(19) United States
(12) Patent Application Publication
(10) Pub. No.: US 2019/0012888 A1
(43) Pub. Date: Jan. 10, 2019

(54) Container With Concealed Sensors

(71) Applicant: Fort Jameson, LLC, Enchinitas, CA (US)

(72) Inventor: Michael Gordon, San Diego, CA (US)

(73) Assignee: Fort Jameson, LLC, Encinitas, CA (US)

(21) Appl. No.: 15/746,778

(22) PCT Filed: Jul. 20, 2016
(86) PCT No.: PCT/US2016/043119

§ 371 Date: Jan. 22, 2018

Related U.S. Application Data
(60) Provisional application No. 62/195,553, filed on Jul. 22, 2015.
(60) Provisional application No. 62/348,061, filed on Jun. 9, 2016.

(51) Int. Cl. G08B 13/14; G08B 13/08

(52) U.S. Cl. CPC G08B 13/14; G08B 13/08; G07C 2009/0092; G07C 2209/62; G07C 2209/08

(57) ABSTRACT

A compartment may include a panel movable between a first position in which the compartment is concealed within a structure and a second position in which the compartment is exposed to an external environment. One or more sensors may be concealed within the structure, where they are actuatable to send signals upon detection of operator inputs. A controller may be programmable to set a predefined or machine-learned, time dependent or non-time dependent sequence of actuation for the one or more sensors, where the controller is configured to receive the signals and to determine whether the predefined or machine-learned sequence of actuation has been achieved by the operator inputs. The controller may be further configured to send a signal to a mechanical element to move the panel ACTUATOR from the first position to the second position when it is determined that predefined or machine-learned sequence of actuation has been achieved.

### CROSS-REFERENCE TO RELATED APPLICATIONS

This application claims priority to U.S. Provisional Application No. 62/348,061 filed on Jun. 9, 2016, and to U.S. Provisional Application No. 62/195,553 filed on Jul. 22, 2015, where each of the foregoing applications is incorporated herein by reference in its entirety.

### FIELD

The present disclosure generally relates to a container with concealed sensors, and more specifically to sensors for detecting operator inputs whereby the sensors may be hidden within or underneath wood, drywall, plastic, or other materials. By way of example, such sensors can be put into furniture, walls, doors, and the like, which can be activated in predefined or machine-learned sequences to perform a variety of functions.

### INTRODUCTION

A variety of sensors are used in the automation and robotics industry. Some of these sensors respond to the presence or absence of metal, water, light, heat, gas, sound, and the like. Some sensors have been used to actuate keyless entry into doors, i.e., when the sensor location is apparent to the operator. Often, these sensors detect a key or “fob” to gain access through a door or other access entry. However, there is a need for a remote, keyless, yet hidden access system, capable of detecting operator inputs, such as a gesture, vocal command, or combination thereof. Such a system could assist an operator in gaining access to a desired location without the presence of a visibly detectable sensor.

### SUMMARY

The present teachings include a system for activating one or more actuators upon detection of an activator sequence by one or more sensors. The system may include a controller, an actuator in electronic communication with the controller, and at least one sensor in electronic communication with the controller. The controller may be programmed to receive an input from the at least one sensor upon a detection by the at least one sensor of a sensed sequence performed by an activator. The controller may be programmed to determine if the sensed sequence substantially matches a predefined or machine-learned, time dependent or non-time dependent, activator sequence. The controller may be programmed to activate the actuator when the sensed sequence substantially matches the activator sequence.

The present teachings include a system for changing the state of a container, where the system may comprise a container, concealment material, at least one sensor, a programmable controller, and an actuator. The container may house the concealment material, the at least one sensor, the programmable controller, and the actuator. The at least one sensor may be in electronic communication with both the actuator and the programmable controller. The programmable controller may be programmed to receive input from the at least one sensor and may be capable of detecting a predefined or machine-learned, time dependent or non-time dependent, activator sequence performed by an activator, including an activator motion in free space. The concealment material may be placed between the at least one sensor and the activator. Upon the at least one sensor detecting and communicating a presence or absence of the activator to the programmable controller, the programmable controller may determine if the activator sequence has been achieved, and the controller may activate the actuator when it is determined that the activator sequence has been achieved thereby changing a state of the container to a desired condition.

In one aspect, the programmable controller is capable of being programmed by an operator via physical (e.g., USB or wired) or wireless (e.g., Bluetooth, Wi-Fi, AirDrop) connection. In another aspect, the activator sequence is an operator motion in free space. In another aspect, the at least one sensor is capable of responding to a presence or absence of motion of the activator in free space. In a further aspect, the container includes, but is not limited to, a piece of furniture, a home, a boat, a car, a garage, or a safe room. In another aspect, the concealment material is non-reactive with respect to the sensor. In another aspect, the concealment material includes, but is not limited to, wood, plastic, drywall, sheet rock, stone, brick, fiberglass, carbon fiber, glass (opaque, transparent, semi-transparent, reflective, and the like), and metal. In another aspect, each of the at least one sensors may be capable of responding to the presence or absence of motion of an activator. In yet another aspect, the at least one sensor can include, but is not limited to, an inductive, acoustic, capacitive, pressure, temperature, infrared, optical, ultrasonic, acceleration, radio frequency identification, or magnetic sensor. In another aspect, the at least one sensor can be turned on or off by an operator to change the activator sequence. In yet another aspect, an operator may define which of the at least one sensors to include or omit from a predefined or machine-learned sequence. In another aspect, the activator is an operator body part. In yet another aspect, the activator comprises a predefined shape and size, and may be constructed of magnetic or non-magnetic metal.

In yet another aspect, the activator comprises the physical properties of liquid, light, heat, sound, or magnetism. In yet another aspect, the actuator can include, but is not limited to, a lock, motor, pump, solenoid, spring-loaded device, transistor, relay, valve, switch, or computer program. In yet another aspect, the container change in state can include, but is not limited to, a change in container accessibility, a change from open to closed, closed to open, locked to unlocked, unlocked to locked, enabled to disabled, or disabled to enabled.

In yet another aspect, the system is housed by a container. Concealment material may be placed between the at least one sensor and the activator. Actuator activation may change a state of the container to a desired condition. Change in the state of the container may be selected from the group consisting of a change in container accessibility, a change from open to closed, closed to open, locked to unlocked, unlocked to locked, enabled to disabled, and disabled to enabled. The container may be selected from the group consisting of a piece of furniture, a home, a boat, a car, a safe, a garage, and a safe room. The concealment material may be non-reactive with respect to the at least one sensor. The concealment material may be selected from the group consisting of wood, ceramic, plastic, drywall, sheet rock, stone, brick, fiberglass, carbon fiber, glass, and metal.

The present teachings also include a system for changing the state of a container, the system comprising a container, a programmable controller, an actuator, at least one sensor, and concealment material, wherein the container houses the controller, actuator, the at least one sensor, and the concealment material, and wherein the at least one sensor is in communication with an operator body part (e.g., an operator's hand or forearm), wherein the concealment material is placed between the at least one sensor and the body part, and the controller connected to the at least one sensor is capable of being programmed to detect a predefined or machine-learned sequence of one, two or three-dimensional body part motions, whereby the state of the container is changed to a desired condition.

A method is also provided for changing the state of the container, the method comprising the acts of (1) an operator moving an activator in a predefined or machine-learned, time dependent or non-time dependent sequence, including but not limited to a sequence of motions in free space, with respect to at least one sensor concealed by concealment material, (2) the at least one sensor detecting and communicating the presence or absence of the activator to the controller, (3) the controller processing the sensor data and determining if the predefined or machine-learned sequence has been achieved, and (4) upon confirmation, the controller activating the actuator, whereby the state of the container is changed.

An additional method is also provided for changing the state of the container, the method comprising the acts of (1) an operator moving an activator in a predefined or machine-learned, time dependent or non-time dependent sequence, including but not limited to a sequence of motions in free space, with respect to at least one sensor concealed by concealment material, (2) the at least one sensor detecting and communicating the presence or absence of the activator to the controller, (3) the controller transmitting the data to a data/cloud network for processing, (4) the data/cloud network processing the data and determining whether the predefined or machine-learned sequence has been achieved, (5) the data/cloud network transmitting the results back to the controller, and (6) upon confirmation, the controller activating the actuator, whereby the state of the container is changed.

An additional method is also provided for changing the state of the container, the method comprising the acts of (1) an operator activating a variety of at least partially concealed sensors, such as capacitive and acoustic sensors, in a predefined or machine-learned, time dependent or non-time dependent sequence, (2) the at least one sensor detecting and communicating the presence or absence of the activator (e.g., operator body part and/or operator voice) to the controller, (3) the controller processing the sensor data and determining if the predefined or machine-learned sequence has been achieved, (4) upon confirmation, the controller activating the actuator, whereby the state of the container is changed.

An additional method is also provided for changing the state of the container, the method comprising the acts of (1) an operator activating a variety of at least partially concealed sensors, such as capacitive and acoustic sensors, in a predefined or machine-learned, time dependent or non-time dependent sequence, (2) the at least one sensor detecting and communicating the presence or absence of the activator (e.g., operator body part and/or operator voice) to the controller, (3) the controller transmitting the data to a data/cloud network for processing, (4) the data/cloud network processing the data and determining whether the predefined or machine-learned sequence has been achieved, (5) the data/cloud network transmitting the results back to the controller, and (6) upon confirmation, the controller activating the actuator, whereby the state of the container is changed.

The present teachings also include a container comprising concealment material, at least one sensor, a programmable controller, and an actuator, wherein the container houses the concealment material, the at least one sensor, the programmable controller, and the actuator, wherein the at least one sensor is in electronic communication with both the actuator and the programmable controller, wherein the programmable controller is programmed to receive input from the at least one sensor and is capable of detecting a detecting a predefined or machine-learned, time dependent or non-time dependent, activator sequence performed by an activator, such as activator motion in free space, wherein the concealment material is placed between the at least one sensor and the activator; and wherein upon the at least one sensor detecting and communicating a presence or absence of the activator to the programmable controller, the programmable controller determines if the activator sequence has been achieved, and the controller activates the actuator when it is determined that the activator sequence has been achieved thereby changing a state of the container to a desired condition.

In another aspect, a system includes a compartment in a structure, the compartment engaged with a panel movable between a first position in which the compartment is at least partially concealed within the structure and a second position in which the compartment is at least partially exposed to an environment external to the compartment. The system may also include a mechanical element engaged with the panel and controllable to move the panel between the first position and the second position, and one or more sensors disposed within or adjacent to the structure, where the one or more sensors actuatable to send one or more signals upon detection of one or more operator inputs. The system may further include a controller including a processor and a memory, the processor programmable to set a predefined or machine-learned sequence of actuation for the one or more sensors, the controller configured to receive the one or more signals and to determine whether the predefined or machine-learned sequence of actuation has been achieved by the one or more operator inputs, and the controller further configured to send a control signal to the mechanical element to move the panel from the first position to the second position when it is determined that predefined or machine-learned sequence of actuation has been achieved. The one or more sensors may be concealed within the structure.

In yet another aspect, a system includes a circuit controllable between a first state in which power is withheld from an endpoint and a second state in which power is provided to the endpoint, and one or more sensors disposed within or adjacent to a structure, where the one or more sensors are actuatable to send one or more signals upon detection of one or more operator inputs. The system may also include a controller including a processor and a memory, the processor programmable to set a predefined or machine-learned sequence of actuation for the one or more sensors, the controller configured to receive the one or more signals and to determine whether the predefined or machine-learned sequence of actuation has been achieved by the one or more operator inputs, and the controller further configured to send a signal to the circuit to switch from the first state to the second state when it is determined that predefined or machine-learned sequence of actuation has been achieved. The structure may be disposed within or adjacent to the endpoint. The circuit may be an electrical circuit and power is withheld from the endpoint when in the first state through an open electrical connection that is closed upon switching from the first state to the second state.

In another aspect, a system includes a compartment in a structure, the compartment engaged with a panel movable between a first position in which the compartment is at least partially concealed within the structure and a second position in which the compartment is at least partially exposed to an environment external to the structure. The system may also include a mechanical element engaged with the panel and controllable to move the panel between the first position and the second position, a first sensor disposed within or adjacent to the structure, the first sensor actuatable to send at least a first signal upon detection of at least a predefined or machine-learned first operator input, and a second sensor disposed within or adjacent to the structure, the second sensor actuatable to send at least a second signal upon detection of at least a predefined or machine-learned second operator input. The system may further include a controller including a processor and a memory, the processor programmable to set a predefined or machine-learned, time dependent or non-time dependent sequence of actuation for at least the first sensor and second sensor, the controller configured to receive the first signal and the second signal and to determine whether the predefined or machine-learned sequence of actuation has been achieved by at least the first operator input and the second operator input, and the controller further configured to send a third signal to the mechanical element to move the panel from the first position to the second position when it is determined that predefined or machine-learned, time dependent or non-time dependent sequence of actuation has been achieved.

In another aspect, a method of changing a state of a container includes moving an activator by an operator in a predefined or machine-learned, time dependent or non-time dependent, activator sequence in free space in proximity to at least one sensor concealed by concealment material, detecting a presence or an absence of the activator by the at least one sensor, sending a signal communicating the presence or absence of the activator to a controller and data related to movement of the activator by the operator, if present, processing the signal and the data by the controller to determine if the activator sequence has been achieved the movement of the activator by the operator, and activating an actuator by the controller upon confirmation that the activator sequence has been achieved thereby changing a state of the container.

In one aspect, a method includes detecting, through one or more sensors at least partially concealed in a structure, one or more operator inputs in a first sequence; sending one or more signals from the one or more sensors to a controller, the one or more signals indicative of the first sequence; receiving the one or more signals at the controller; comparing the first sequence to a predefined or machine-learned sequence of actuation for the one or more sensors thereby determining whether the predefined or machine-learned sequence of actuation has been achieved by the one or more operator inputs; and sending a signal to a mechanical element to change a state of a concealed compartment when it is determined that predefined or machine-learned sequence of actuation has been achieve by the one or more operator inputs.

In one aspect, a method of manufacturing a container includes assembling concealment material, at least one sensor, a programmable controller, and an actuator within the container, placing the at least one sensor in electronic communication with the programmable controller, the at least one sensor capable of detecting and communicating a presence or an absence of an activator to the programmable controller, programming the programmable controller to receive input from the at least one sensor such that the programmable controller and at least one sensor are capable of detecting a predefined or machine-learned, time dependent or non-time dependent, activator sequence performed by the activator in free space, placing the concealment material between the at least one sensor and the free space, and programming the programmable controller to determine if the activator sequence has been achieved.

These and other features, aspects and advantages of the present teachings will become better understood with reference to the following description, examples and appended claims.

### DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 depicts a container with a concealed sensor.

FIG. 2 depicts a container with multiple concealed sensors.

FIG. 3 illustrates a system for a container with concealed sensors.

FIGS. 4-7 depict various configurations and programmable states for sensor configurations.

FIG. 8 depicts an electrical diagram according to an implementation.

FIG. 9 illustrates a system with a controllable compartment based on detected operator inputs.

FIG. 10 illustrates a system with a controllable circuit based on detected operator inputs.

FIG. 11 is a flow chart of a method for detecting operator inputs.

FIG. 12 is a flow chart of a method for detecting operator inputs to change the state of a container.

FIG. 13 is a flow chart of a method for changing a state of a container.

FIG. 14 is a flow chart of a method for manufacturing a container.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

Described herein are devices and systems which comprise concealed sensors, and methods for making and using such devices and systems comprising concealed sensors. In one such method, the concealed sensors may be used to change the state of an object, e.g., a compartment, container, and the like. In this manner, unless explicitly stated to the contrary or otherwise clear from the context, as used herein, the term “state” refers to the position or relative change in the accessibility of an object, such as whether the object is opened or closed, locked or unlocked, enabled or disabled, and the like. Further, unless explicitly stated to the contrary or otherwise clear from the context, as used herein, the terms “container,” “compartment,” and the like should be interchangeable and broadly interpreted to include, a housing, a room, a wall, a box, a safe, an encasement, a case, a chamber, an enclosure, a cavity, a hole, an opening, a passage, a reservoir, a car, a house, a garage, a piece of furniture, and the like. In general, the container may include one or more access points or the like, such as a door, a window, a panel, and so on. The access point may be engaged with the container through any known means, including without limitation, use of one or more of a hinge, a slider, a clamp, a clip, a coupling, a friction fit, an adhesive, a joint, a key, a lock, a pin, a seam, a snap fit, and the like.

Implementations described herein may function through the use of an actuator. In this manner, as used herein, the term “actuator” may refer to a lock, a motor, a spring-loaded device, a relay, a transistor, a solenoid, a switch, a computer program, and the like which is capable of changing the state of a container. The term “actuator” may also or instead include mechanical actuators, e.g., linear actuators and the like, used to mechanically open/close or otherwise change the state of a container through the techniques described herein.

Implementations described herein may include machine-learned sequences. In this manner, as used herein, the term “machine-learned” may refer to sequences of operator inputs, such as sensor and switch activations, which may be learned or ‘mapped’ by the system's software by means of operator demonstration rather than by manual programming. In this way, an operator may teach a sequence of operator inputs to the system's software by performing a gesture, activating switches, recording a vocal command, and the like, while the software is in a learning mode. The system's software may be able to learn such sequences of operator inputs by utilizing techniques such as algorithms, digital signal processing, analog to digital conversions, and the like. Such algorithms and software may be predefined, and in various embodiments can be updated, e.g., via the Internet. The systems and devices described herein may have software and algorithms preloaded, or may require installation of the software or algorithms before the systems or devices are operable.

Implementations may generally include one or more sensors, which can be fully concealed, partially concealed, and any combination thereof. Exposed sensors may be implemented when in addition to concealed or partially concealed sensors. For example, if a plurality of sensors is used, one or more sensors may not be concealed (i.e., may be visible or otherwise accessible) while the remainder are concealed. The sensors may include, e.g., infrared sensors, capacitive sensors, acoustic sensors, inductive sensors, ultrasonic sensors, acceleration sensors, thermal sensors, pressure sensors, proximity sensors, or other sensors and devices capable of detecting something of interest, such as a change in the environment in which it is located. Combinations of such sensors are contemplated in a variety of embodiments disclosed herein.

Actuation of devices and systems disclosed herein may be through movement or placement of a body part. In this manner, unless explicitly stated to the contrary or otherwise clear from the context, as used herein, the term “body part” may refer to an operator's body, and parts of the operator's body such as an arm, a hand, a finger, or another body part. Actuation may also or instead utilize other items, which may be referred to herein as activators, such as tools, jewelry or instruments in control of the operator. Activators may also or instead include an operator's body part. Furthermore, unless stated to the contrary or otherwise clear from the context, the terms “user” and “operator” may have the same meaning and be used interchangeably throughout this disclosure.

As stated above, actuation of devices and systems disclosed herein may also or instead be accomplished through an activator. In this manner, unless explicitly stated to the contrary or otherwise clear from the context, as used herein, the term “activator” refers to an object or energy that is detectable by a sensor, and thus may change the state of the sensor. For example, a body part, which contains water, may be detectable by a capacitive sensor and thus may be regarded as an activator for a capacitive sensor. Alternatively, sound is detectable by an acoustic sensor and thus sound, or an operator's voice, may be an activator of an acoustic sensor. Alternatively, metal may be detectable by an inductive sensor, and thus metal may be an activator of an inductive sensor. An activator, such as an operator's hand, may be used to perform a predefined or machine-learned sequence of sensor activation, such as a gesture in free space within the detectable volume/range of at least one sensor. Combinations of activators may be used within a predefined or machine-learned sequence. The activator may also or instead refer to an object having a predefined shape and size which is designed to interact with the at least one sensor by means of its geometrical and physical properties. Such an object may be referred to as a “dumb key.”

Implementations of the device and systems may include concealment, e.g., of the sensors, the container (or a component or part thereof), and so on. Concealment as used herein may include the complete or partial concealment or hiding from the naked eye of any component described as such. Concealment may not interfere with the function of the components of the devices, systems, and methods described herein. Thus, unless explicitly stated to the contrary or otherwise clear from the context, as used herein, the term “concealment material” may refer to a material that is neutral, or inert, with respect to the sensors. By way of example, wood, drywall, sheet rock, stone, brick, fiberglass, carbon fiber, and glass may not typically interfere with certain types of sensors, yet these concealment materials can generally conceal or hide sensors from the naked eye.

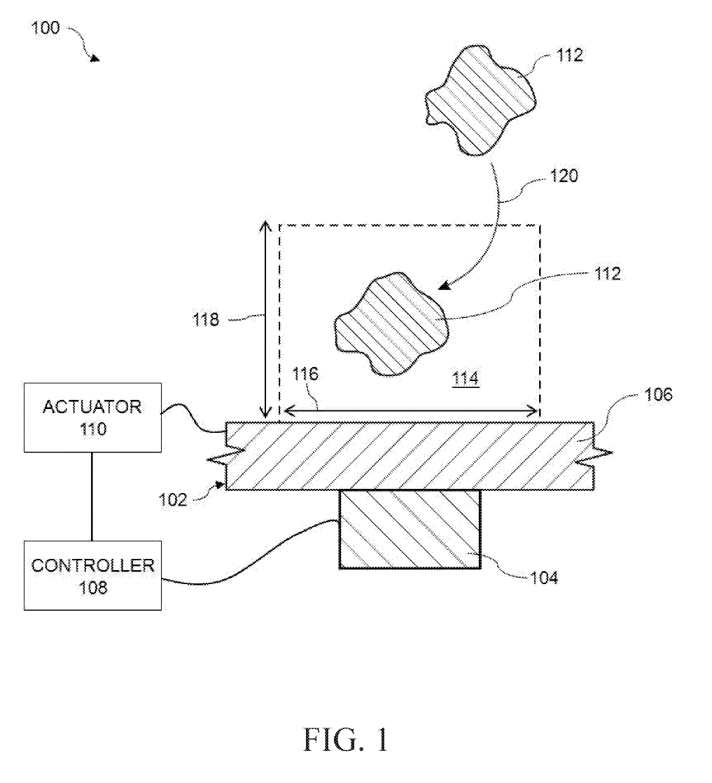

FIG. 1 depicts a container with a concealed sensor. As shown in the figure, a system 100 may be provided for changing the state of a container 102 using one or more sensors 104. This may be accomplished through the use of a remote keyless, yet hidden, access system using a predefined or machine-learned, time dependent or non-time dependent sequence of gestures, e.g., an activator sequence. Such a system 100 can provide access to a desired location (e.g., inside of a container 102) without the presence of the sensor 104 being detected. This can be advantageous, for example, to avoid a child having access to a box or room containing hazardous materials. As described in the examples included herein, the system 100 can allow access to a locked box, a room in a home, and the like. More specifically, the system 100 may include a container 102, at least one sensor 104, concealment material 106, a programmable controller 108, an actuator 110, and an activator 112.

As shown in the figure, the activator 112 may be disposed outside the detectable volume 114 of the sensor 104. The detectable volume 114 may be determined by the working width 116 of the sensor 104, the working height 118 of the sensor 104, and a working depth of the sensor 104 (the third dimension facing in/out of the drawing sheet), which creates a volume of space in which the sensor 104 is capable of detecting a change in environment. When the activator 112 is moved within the detectable volume 114 of the sensor 104, as depicted by the arrow 120, the sensor 104 may be activated. The concealment material 106 may keep the sensor 104 out of visible detection of an operator or to someone unfamiliar with the system 100.

The container 102 may include the concealment material 106, the at least one sensor 104, the programmable controller 108, and the actuator 110. The container 102 can be configured in a variety of ways, and in particular where the concealment material 106 resides between the sensor 104 and the activator 112, which can be moved in one, two, or three dimensions. The container 102 may be any as described herein, including a piece of furniture, a home, a boat, a car, a garage, and a safe room. The sensor 104, or at least one other sensor, may be in electronic communication with either or both of the actuator 110 and the programmable controller 108. Similarly, the actuator 110 may be in electronic communication with one or more of the programmable controller 108 and the sensor 104. In this manner, in an aspect, once the sensor 104 is activated by the activator 112 (e.g., through body part gesturing or an object having a pre-defined shape), the actuator 110 can be triggered thus changing a state of the container 102, e.g., opening the container 102.

The controller 108 may be programmed to receive an input from the sensor 104 upon a detection by the sensor 104 of a sensed sequence performed by the activator 112. The controller 108 may be programmed to determine if the sensed sequence substantially matches a predefined or machine-learned, time dependent or non-time dependent, activator sequence. The controller 108 may be programmed to activate the actuator 110 when the sensed sequence substantially matches the activator sequence.

The controller 108 may include any hardware or software required to analyze the data from the at least one sensor 104 and determine if a predefined or machine-learned sequence of an activator 112 motion in one, two, or three-dimensional free space has been achieved. Those skilled in the art will recognize that a variety of different controllers may be used in the implementations described herein, for example, an Arduino controller, Raspberry Pi, PIC microcontroller, and the like. The programmable controller 108 may be capable of being programmed by an operator via a physical (e.g., USB or wired) or wireless (e.g., Bluetooth, Wi-Fi, AirDrop) connection. Thus, the controller 108 may include a network connection, a processor, a memory, and any other hardware or software to perform its functions as described herein.

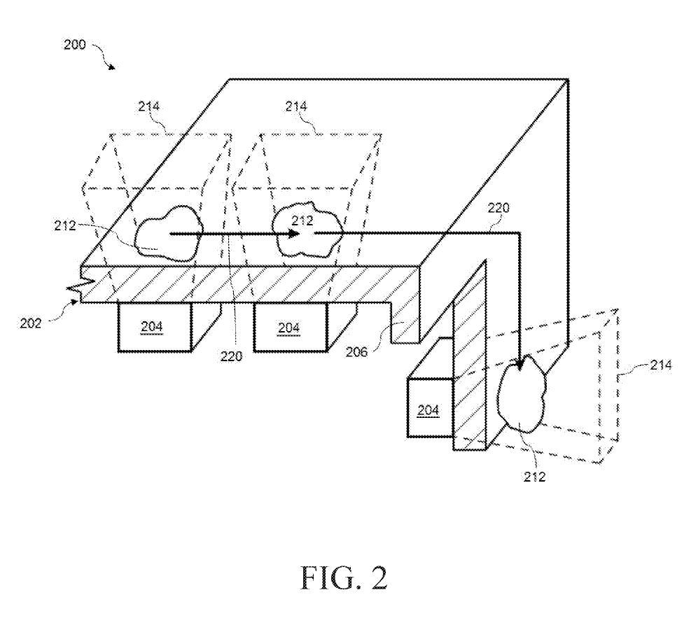

FIG. 2 depicts a container with multiple concealed sensors. The system 200 may include a container 202, a plurality of sensors 204 each with its own associated working volume 214, concealment material 206, and an individual or plurality of activators 212 (e.g., objects).

As shown in the figure, the concealment material 206 may be disposed between the one or more sensors 204 and the activator 212 where, upon the at least one sensor 204 detecting a predefined or machine-learned sequence of activator motions in free space (e.g., by a user/operator motion in free space), the controller activates the actuator whereby the container 202 changes state to a desired condition. The predefined or machine-learned sequence is, for example, shown by the arrows 220 which show the activator 212, or plurality of activators, moved into different working volumes 214 of different sensors 204. The concealment material 206 may be substantially non-reactive with respect to the sensors 204. In various configurations, the concealment material 206 includes, but is not limited to, wood, drywall, stone, brick, fiberglass, carbon fiber, glass, metal, plastic, rubber, sheet rock, ceramic, and the like. For example, if a sensor 204 being used is a capacitive sensor, the concealment material 206 may not contain water, or if it contains water, the sensor 204 sensitivity may be adjusted such that it is capable of detecting the activator 212. The sensitivity of other sensors described herein may be adjusted according to the properties comprised by the selected concealment material. Each of the plurality of sensors 204 may be capable of responding to the presence or absence of motion of an activator 212 in one, two, or three-dimensional free space.

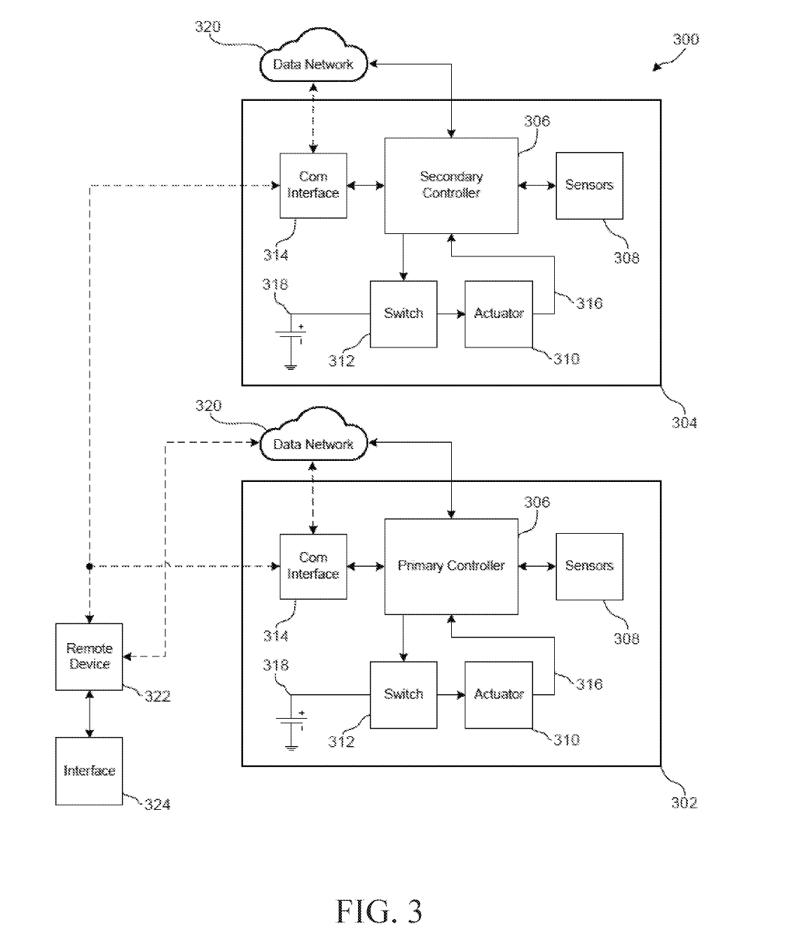

FIG. 3 illustrates a system for a container with concealed sensors. The system 300 may include a primary circuit 302, a secondary circuit 304 (e.g., a wireless ‘sleeper’ system), controllers 306, sensors 308, actuators 310, switches 312, communication interfaces 314, feedback loops 316, power sources 318, a data network 320, a remote device 322, and an operator interface 324.

The primary circuit 302 may be typically installed within or adjacent to the container with concealed sensors. A responsibility of the primary circuit may be to change the state of the container by controlling actuators 310. Any secondary circuits 304 (e.g., a sleeper system), which may contain all of the functionality of a primary circuit 302, can communicate with the primary circuits wirelessly through communications interface 314. If predefined by an operator, a primary circuit 302 may require authorization or data from a secondary circuit 304 to operate. Both the primary and secondary circuits may communicate with a remote device 322 via communication interfaces 314.

The controllers 306 may be electrically coupled in a communicating relationship, e.g., an electronic communication, with any of the components of the system 300. In general, the controllers 306 may be operable to control the components of the system 300, such as the sensors 308 and switches 312. The controllers 306 may include any combination of software and/or processing circuitry suitable for controlling the various components of the system 300 described herein including without limitation processors, microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and the like. In one aspect, the controllers 306 may include a microprocessor or other processing circuitry with sufficient computational power to provide related functions such as executing an operating system, providing a graphical user interface (e.g., to a display coupled to the controllers 306 or another component of the system 300), set and provide rules and instructions for operation of the container or another component of the system 300, and operate a web server or otherwise host remote operators and/or activity through the communications interface 314.

The controllers 306 may include a printed circuit board, an Arduino controller or similar, a Raspberry Pi controller or the like, a prototyping board, or other computer related components.

The sensors 308 may include one or more of capacitive sensors, inductive sensors, ultrasonic sensors, optical sensors, infrared sensors, temperature sensors, sound sensors, chemical sensors (e.g., oxygen, carbon-dioxide, and so on), motion and proximity sensors, magnetic sensors, radio sensors, flow sensors, radiation sensors, imaging sensors, pressure sensors, shock sensors, force sensors, and the like. The sensors 308 can be fully concealed, partially concealed, and any combination thereof. Exposed sensors may be implemented when in addition to concealed or partially concealed sensors. In general, the sensors 308 may include a sensor to detect a presence or absence of an object at a predetermined location.

The sensors 308 may also or instead include more complex sensing and processing systems or subsystems, such as a three-dimensional scanner using optical techniques (e.g., stereoscopic imaging, shape from motion imaging, and the like), structured light techniques, or any other suitable sensing and processing hardware that might extract information from a predetermined volume.

The sensors 308 may be turned on or off by an operator to change the activator sequence.

The actuators 310 may be the mechanical element(s) that allow the container to change from one state to another state. This may include, without limitation, linear actuators (or other actuators), valves, solenoids, motors, belts, pulleys, conveyors, gears, digital or analog signals to secondary systems, and so on. More generally, the actuators 310 may include without limitation various combinations of stepper motors, encoded DC motors, gears, belts, pulleys, worm gears, threads, and the like. Any such arrangement suitable for controllably positioning an access point of the container may be used herein.

The switch 312 may transmit energy from the power source 318 to the actuators 310. Switches may include mechanical switches (e.g., a rocker switch) or electrical switches such as transistors, MOSFETS, or relays.

The communications interface 314 may be suited such that any of the components can communicate with one another. Thus, the communications interface 314 may be present on one or more of the components of the system 300. The communications interface 314 may include, or be connected in a communicating relationship with, a network interface or the like. The communications interface 314 may include any combination of hardware and software suitable for coupling the components of the system 300 to a remote device 322 (e.g., a remote computer) in a communicating relationship through a data network 320. By way of example and not limitation, this may include electronics for a wired or wireless Ethernet connection operating according to the IEEE 802.11 standard (or any variation thereof), or any other short or long range wireless networking components or the like. This may include hardware for short range data communications such as Bluetooth or an infrared transceiver, which may be used to couple into a local area network or the like that is in turn coupled to a data network such as the Internet. This may also or instead include hardware/software for a WiMax connection or a cellular network connection (using, e.g., CDMA, GSM, LTE, or any other suitable protocol or combination of protocols). Additionally, the controllers 306 may be configured to control participation by the components of the system 300 in any network to which the communications interface 314 is connected, such as by autonomously connecting to the network to retrieve status updates and the like.

The feedback loop 316 may transmit data, typically positional data, from the actuator(s) 310 to the controller 306. Data from the feedback loop 316 may be used to confirm that the actuator(s) 310 have performed the functions as directed by the controller 306. Components of a feedback loop 316 may include any mechanical or electrical elements that verify the functionality or position of an actuator 310. This may include optical encoders, linear encoders, rotary encoders, sensors (e.g., Hall-effect, optical, proximity), potentiometers, and the like.

The power sources 318 may be any known in the art or that will become known in the art. For example, power sources 318 may include an AC to DC converter (e.g., grid power), solar power, battery power, wind power, fossil fuel sourced power, and so on.

The data network 320 may be any network(s) or internetwork(s) suitable for communicating data and control information among participants in the system 300. This may include public networks such as the Internet, private networks, telecommunications networks such as the Public Switched Telephone Network or cellular networks using third generation (e.g., 3G or IMT-2000), fourth generation (e.g., LTE (E-UTRA) or WiMax-Advanced (IEEE 802.16m) and/or other technologies, as well as any of a variety of corporate area or local area networks and other switches, routers, hubs, gateways, and the like that might be used to carry data among participants in the system 300. The data network 320 may include wired or wireless networks, or any combination thereof. One skilled in the art will also recognize that the participants shown the system 300 need not be connected by a data network 320, and thus can be configured to work in conjunction with other participants independent of the data network 320.

The remote device 322 may include any devices within the system 300 operated by operators or otherwise to manage, monitor, communicate with, or otherwise interact with other participants in the system 300. This may include desktop computers, laptop computers, network computers, tablets, smart phones, smart watches, PDAs, or any other computing device that can participate in the system 300 as contemplated herein. In one aspect, the remote device 322 (and an operator interface thereof) is integral with the container or structure housing the container.

The remote device 322 may generally provide an operator interface 324, which may include a graphical user interface, a text or command line interface, a voice-controlled interface, and/or a gesture-based interface. In general, the operator interface 324 may create a suitable display on the remote device 322 for operator interaction. In implementations, the operator interface 324 may control operation of one or more of the components of the system 300, as well as provide access to and communication with controllers 306 and other resources.

The operator interface 324 may be maintained by a locally executing application on the remote device 322 that receives data from one or more of the components of the system 300 or other resources. In other embodiments, the operator interface 324 may be remotely served and presented on one of the remote devices 322, such as where the container or controllers 306 include a web server that provides information through one or more web pages or the like that can be displayed within a web browser or similar client executing on one of the remote devices 322. In one aspect, the operator interface 324 may include a voice controlled interface that receives spoken commands from an operator and/or provides spoken feedback to the operator. In yet another aspect, the operator interface 324 works in conjunction with the sensors 308. In implementations, the operator interface 324 may also or instead be provided by and/or disposed on another participant in the system 300.

Other hardware of system 300 may include input devices such as a keyboard, a touchpad, a computer mouse, a switch, a dial, a button, and the like, as well as output devices such as a display, a speaker or other audio transducer, light emitting diodes, and the like. Other hardware of system 300 may also or instead include a variety of cable connections and/or hardware adapters for connecting to, e.g., external computers, external hardware, external instrumentation or data acquisition systems, and the like.

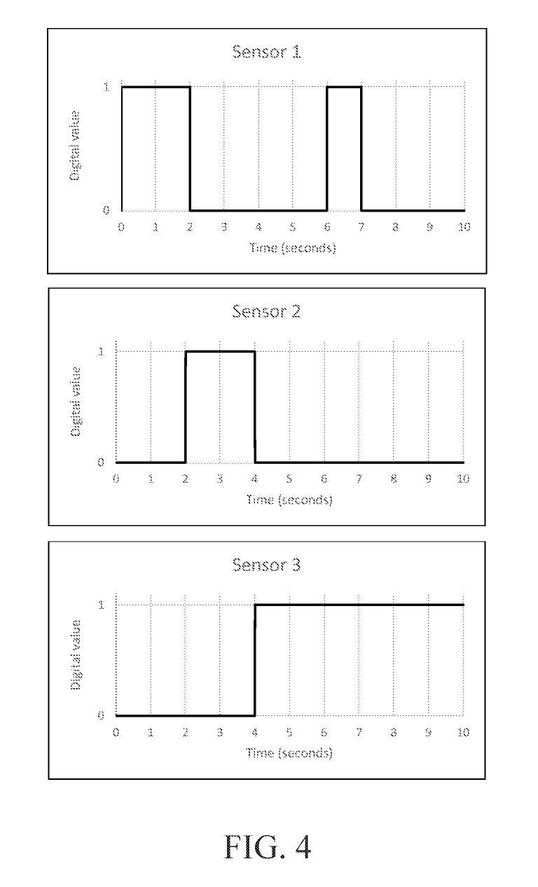

FIGS. 4-8 depict various configurations and programmable states for sensor configurations. In one aspect, the at least one sensor can include, but is not limited to, inductive, acoustic, capacitive, infrared, optical, ultrasonic, and magnetic sensors. In one aspect, a combination of different sensors (e.g., capacitive and inductive sensors) is used to detect the activator. In another aspect, each of the at least one sensors can be added to or subtracted from a predefined or machine-learned sequence of an activator motion in one, two or three-dimensional free space. In another non-limiting example, the activator may also or instead refer to an object having a predefined shape and size which is designed to interact with the sensor(s) by means of its geometry and physical properties. Such an object can be referred to as a “dumb key.” The activator may also or instead be constructed of magnetic or non-magnetic metal. The activator may also or instead include the physical properties of one or more of liquid, light, heat, sound, magnetism, and the like.

The actuator can include a lock, motor, solenoid, pump, spring-loaded device, transistor, relay, switch, and computer program which can change the container's state from, for example, a change in container accessibility, a change from open to closed, closed to open, locked to unlocked, unlocked to locked, enabled to disabled, disabled to enabled, and so forth.

In a particular embodiment, a system for changing the state of a container is provided, the system comprising a container, a programmable controller, an actuator, at least one sensor, and concealment material, wherein the container houses the controller, actuator, the at least one sensor, and the concealment material, and wherein the at least one sensor is in communication with an operator body part, wherein the concealment material is placed between the at least one sensor and the body part (or other activator), and the controller connected to the sensor is capable of being programmed to detect a predefined or machine-learned, time dependent or non-time dependent two-dimensional or three-dimensional sequence of body part motions, whereby the state of the container is changed to a desired condition. The change in the state of the container may include one or more of a change in container accessibility, a change from open to closed, closed to open, locked to unlocked, unlocked to locked, enabled to disabled, disabled to enabled, and the like. The container may include one or more of a piece of furniture, a home, a boat, a car, a safe, a garage, a safe room, and the like.

A method is also provided for changing the state of the container, the method comprising the acts of (1) an operator moving an activator in a predefined or machine-learned sequence in free space with respect to at least one sensor, (2) the at least one sensor detecting and communicating the presence or absence of the activator to the controller, (3) the controller processing the data from the at least one sensor to determine if the predefined or machine-learned sequence of activator motion in free space has been achieved, and (4) upon confirmation, the controller activating the actuator, whereby the state of the container is changed.

The present teachings also include a device comprising a container, concealment material, at least one sensor, a programmable controller, and an actuator, wherein the container houses the concealment material, the at least one sensor, the programmable controller, and the actuator in a variety of configurations. The at least one sensor is in electronic communication with both the actuator and the programmable controller, and the controller is programmed to receive input from the at least one sensor and is capable of detecting a predefined or machine-learned sequence of an activator motion in free space. The concealment material is placed between the at least one sensor and the activator, and upon the at least one sensor detecting the predefined or machine-learned sequence of activator motions in free space, the controller activates the actuator whereby the container changes state to a desired condition.

As described herein, the sensors may be actuated through one or more operator inputs that conform, or substantially conform within a predetermined tolerance, to a predefined or machine-learned sequence. The predefined sequence may include one or more of the following features: it may be time dependent or non-time dependent, motion based, force based, light based, color based, gesture based, and so forth.

As shown in FIG. 4, in an aspect, a predetermined period of time may begin when a sequence is first initiated. As shown in the figure, the predetermined period of time may, e.g., be about 10 seconds (s). One of ordinary skill in the art will recognize that the predetermined period of time may instead include more or less time, and that any timeframes stated herein are provided by way of example only, and may include, by way of example 0.01 s, 0.1 s, 0.2 s, 0.3 s, 0.4 s, 0.5 s, 0.6 s, 0.7 s, 0.8 s, 0.9 s, 1 s, 2 s, 3 s, 4 s, 5 s, 6 s, 7 s, 8 s, 9 s, 10 s, 11 s, 12 s, 13 s, 14 s, 15 s, 16 s, 17 s, 18 s, 19 s, 20 s, 30 s, 40 s, 50 s, 60 s, 120 s, 180 s, numbers in between such timeframes, and so on, or completely untimed. In the example shown in the figure, the time allotted is 10 seconds, meaning that the operator has 10 seconds to complete the predefined sequence to activate an implementation, e.g., open or unlock a container. Alternatively, the operator may have 10 seconds to initiate the sequence to activate an implementation.

In one aspect, sensors may be designated to be HIGH or LOW for specific segments of the predetermined sequence time period. Within the sequence, the sensors may repeat more than once and may be activated concurrently, thus overlapping one another. In an aspect, a sensor may be HIGH when it is actuated, e.g., detecting an input, and a sensor may be LOW when it is unactuated, e.g., no longer detecting an input. This may also be reversed, or alternatively, the sensor may be detecting a plurality of inputs in order to place the sensor in a HIGH state or a LOW state. One skilled in the art will recognize that other combinations and alternatives are also or instead possible, and those referenced herein are provided by way of example only.

In this manner, the controller's software (or data/cloud network) may sense or record each sensor's state for the duration of the sequence and determine whether a specific predefined or machine-learned activator sequence is matched through an analysis of the sensor data. To this end, the controller (or data/cloud network) may determine whether the sensors were HIGH or LOW at predefined times or sequences. An example is provided in the figure, where, in times within the 10 second period, Sensor 1 is HIGH, then Sensor 2 is HIGH, then Sensor 3 is HIGH (and remains HIGH), and then Sensor 1 is HIGH again. This sequence, which may have been predefined by an operator, contains a time period when both Sensor 1 and Sensor 3 are high. This overlap means that both sensors must be in a HIGH state between seconds 6 through 7. Either during the sequence or after its completion, the controller's software (or data/cloud network) may verify that Sensor 1 was HIGH only during seconds 0 through 2 and seconds 6 through 7. The software may verify that Sensor 2 was HIGH only during seconds 2 through 4. The software may also verify that Sensor 3 was HIGH only during seconds 4 through 10. These verifications may also check to ensure that each of the sensors were LOW at the appropriate times. This predefined sequence may be modified to add or subtract sensors, increase or decrease sequence complexity, increase or decrease sequence time, or add an ‘acceptability window’ around each change-of-state to account for human error. This type of sequence, where sensor activation may be overlapping one another within a predefined time period, will be referred to as an “Overlap” sequence.

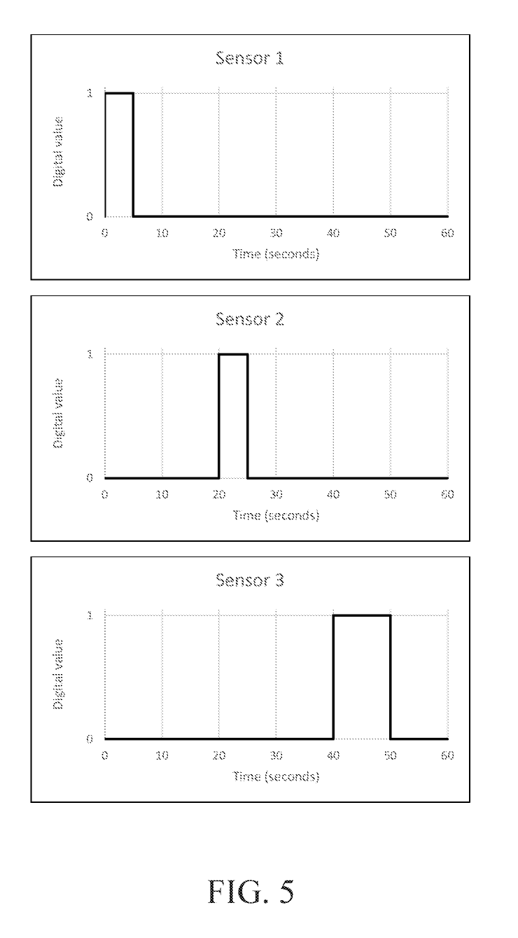

As shown in FIG. 5, in an aspect, the sequence may be untimed, or a longer allotment of time may be provided. Within this allotted time, the sensors may be required to be activated sequentially, in an order that may be predefined by an operator. An activated sensor must return to a LOW state before the next sensor in the sequence may change to a HIGH state. In this mode of operation, the duration that each sensor is HIGH or LOW and the duration between sensor activation is irrelevant as long as the sequence is completed in its entirety during the allotted time period. If two or more sensors are activated concurrently, the system may log a ‘failed entry’ and reset. If sensors are activated in an incorrect sequence, the system may log a ‘failed entry’ and reset. Again, as shown in the figure, a predetermined period of time (e.g., 60 seconds) may begin when a sequence is first initiated. Then, within that period of time, the controller may check to determine if the sensors were activated in a correct predefined sequence. For example, as shown in the figure, the commencement of the sequence began when Sensor 1 changed state to HIGH. Then the controller may check to see if Sensor 1 switched from HIGH to LOW before the next sensor in the sequence, Sensor 2, switched from LOW to HIGH. It would then verify that Sensor 2 switched from HIGH to LOW before Sensor 3 switched from LOW to HIGH. If this is true, the controller may change the state of the container. This type of sequence, where sensors must be activated sequentially, may be referred to as an “Untimed” sequence.

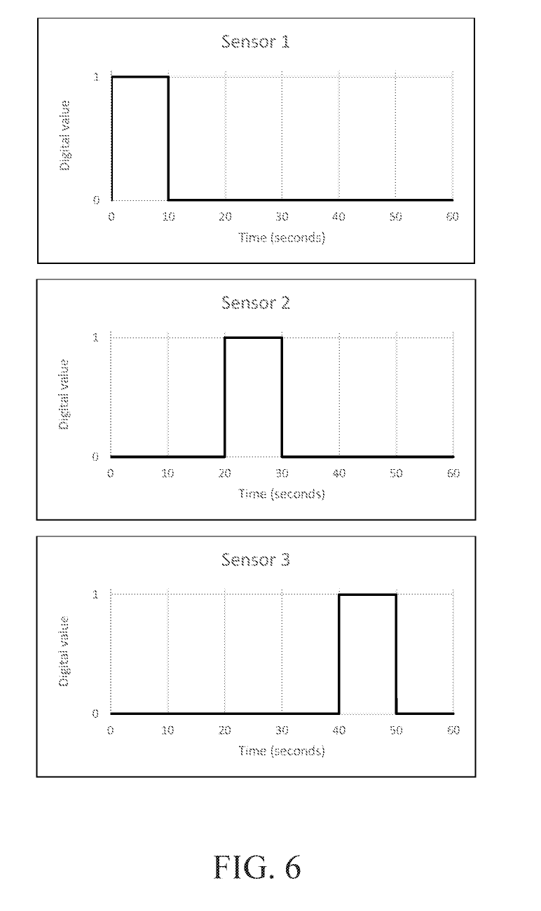

As shown in FIG. 6, in an aspect, time may be a measured variable of a predefined sequence. The times at which each sensor changes state and the durations between sensor activations may be predefined by an operator. Again, as shown in the figure, a predetermined period of time may begin when a sequence is first initiated (e.g., 60 seconds). Within that period of time, the controller (or data/cloud network) may verify that the sensors were activated in the predefined sequence, at the predefined times within the sequence, and for the predefined amounts of time. By way of example, the controller (or data/cloud network) would verify that only Sensor 1 was HIGH for the first 10 seconds of the sequence, followed by a 10 second delay in which all sensors were low. If this was true, it would verify that only Sensor 2 was HIGH between seconds 20 and 30, followed by a 10 second delay in which all sensors were LOW. If this was true, it would verify that only Sensor 3 was HIGH between seconds 40 and 50, followed by a 10 second delay in which all sensors were LOW. If this was true, the controller (or data/cloud network) may change the state of the container. A predefined sequence may be modified to add or subtract sensors, increase or decrease sequence complexity, increase or decrease sequence time, or add an ‘acceptability window’ around each change-of-state to account for human error. This type of sequence, where time may be a measured variable of the sequence, may be referred to as a “Timed” sequence.

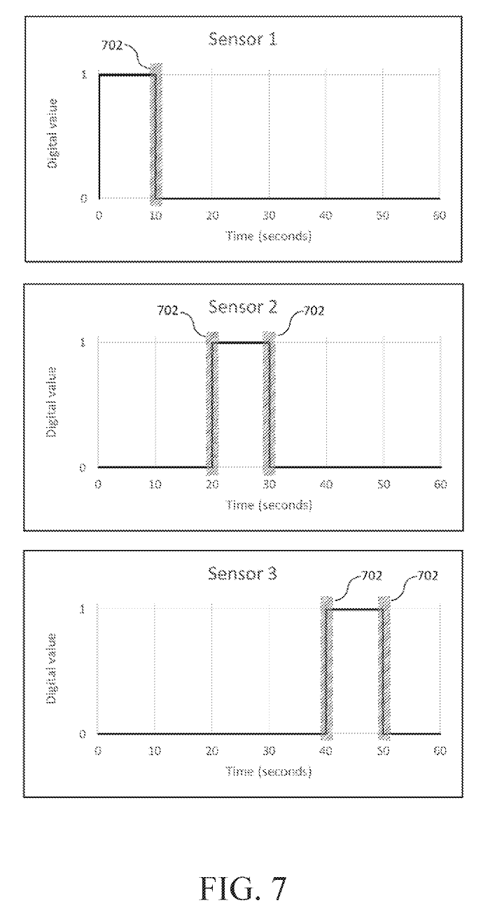

As shown in FIG. 7, a predefined sequence may require a tolerance band associated with each change-of-state. This tolerance band defines a period of time in which a sensor may change state and stay within, or compliant to, a predefined sequence. This ‘acceptability window’ 702 may adjust the sensitivity of the sequence to account for human error. This may be particularly useful in an embodiment where sensors (e.g., capacitive sensors) are activated by a body part (e.g., a hand). It is possible that a person can memorize a predefined sequence of sensor activation, but because of human error and limitations, they cannot precisely achieve these benchmarks. Additionally, the sensors may include a variable working distance/area/volume, and may be activated/deactivated inadvertently (e.g., the sensor may be activated before a hand is over the sensor, and may be deactivated only after the hand is a certain distance away from the sensor). As shown in FIG. 7, a solution for this human-machine communication gap is the addition of an ‘acceptability window’ 702 around each predefined sensor/button/switch change-of-state. Acceptability windows 702 can be static or dynamic. If they are predefined to be static, their position within the sequence may not adjust to accommodate the stack-up of human error within the sequence. In FIG. 7, a ±1 second acceptability window 702 is shown around each change-of-state. Thus, in a static scenario, it would be acceptable for an operator to deactivate Sensor 1 anytime between 9 and 11 seconds into the sequence. If the operator deactivates Sensor 1 at 9 seconds, the acceptability window for the activation of Sensor 2 will remain at 19 to 21 seconds. If the acceptability window was predefined to be dynamic, and the operator deactivated Sensor 1 at 9 seconds, the whole downstream sequence would shift 1 second earlier, and the acceptability window for the activation of Sensor 2 would now be 18 to 20 seconds into the sequence. In an aspect, the larger the acceptability window, the less sensitive the system is, i.e., a small acceptability window would work well for someone with fast reflexes. It is also within the capability of the system's software to adjust the predefined sequence, in real time, to account for human error.

The sequences and patterns described above may be the same or similar to those described in U.S. Pat. No. 7,394,346, which is hereby incorporated by reference herein in its entirety.

Different modes will now be discussed, where several are presented by way of example.

An implementation may include one or more standby modes. In an aspect, the system is typically off, and it is turned on by an operator, e.g., through a switch, button, or the like. When the system is turned on, all of the sensors may turn on and the system is then ready (or it is ready after the controller or other component boots up). Such modes may be advantageous in battery powered systems.

An implementation may include one or more sleep modes. In an aspect, the controller and the first sensor in the predetermined sequence are typically powered. When the first sensor is activated, power may be supplied to the remainder of the sensors and other components in the system. Such techniques may conserve energy when the system is not in use.

An implementation may include a mode in which the system is always on.

As discussed throughout, the sensors or other components of the devices, systems, and methods described herein, may be concealed. In lieu of concealment, or in addition to concealment, the system may include one or more “Sleepers.” Sleepers may include a sensor, button, switch, or the like, that is not an obvious part of the predetermined sequence. Sleepers may be useful because, without Sleepers, if someone observes an operator performing the sequence, the observer may be able to repeat the sequence, e.g., if all of the steps in the sequence were obvious. As with other components of the systems described herein, the Sleeper may be wired directly to the controller or connected wirelessly.

A Sleeper may provide an operator with the ability to open up a ‘time window’ or the like (e.g., from a remote location) to perform the predefined or machine-learned sequence. By way of example, a sensor may be hidden in a stairwell where activation of the sensor can open up a five minute window for a system at an end of the stairwell to be activated. In this manner, an operator traversing the stairs can discretely turn the system on. In this example, any password observers will likely not notice the activation of the Sleeper system, making the observed password useless.

Another example of a Sleeper is the use of a signal from a remote device, e.g., a cellular phone or other mobile device. In this manner, a signal from a cellular phone (application or app) can activate the system. In an implementation, a cellular phone app can be downloaded by the operator to do one or more of the following, once their identity is verified: change the timing of any sequence, change any sensitivity settings, disable sensors (e.g., if the sensor is disposed in a undesirous location), enable sensors, change the predefined sequence, troubleshoot problems, allow the operator to teach the system a new sequence by means of demonstration (machine-learned sequence), override the system, change modes, and so forth.

Aspects of the present teachings may be further understood in light of the following examples, which should not be construed as limiting the scope of the present teachings in any way. For example, in many instances, the materials, objects, components, signals, methods, and so forth, may be amended or supplemented in the examples provided without departing from the general scope of this disclosure.

### Example 1—Furniture

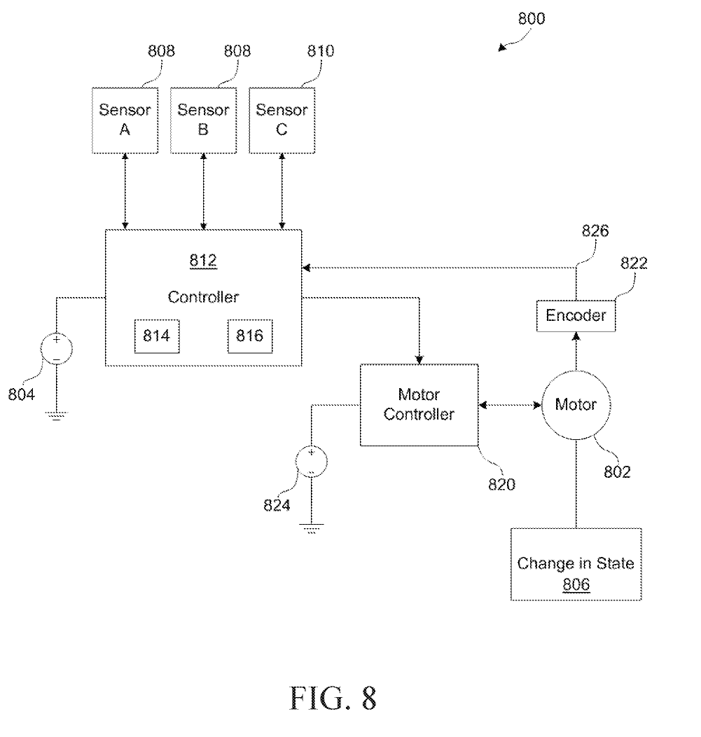

In this example, a wooden desk is designed with a hidden compartment that, when authorized, becomes accessible to an operator. FIG. 8 is an electrical diagram according to an implementation, and displays a possible schematic 800 for Example 1. As shown in the figure, an actuator 802 (e.g., a DC stepper motor) and power source 824 (e.g., a battery) were selected to change the state of compartment 806 from inaccessible to accessible, or concealed to visible. In an effort to conceal the hidden compartment, the desk was designed without any visible buttons or switches, which have the potential of being found with enough investigation. Instead, concealed sensors were used, e.g., two capacitive sensors 808 and one inductive sensor 810. The sensors may be fully functional through the desk materials, such as wood, and may be inlayed into the wood in multiple geometric planes.

The system may comprise an actuator 802 (e.g., stepper motor), a low voltage power source 804, sensors 808 and 810, a controller 812 including a processor 814 and a memory 816 (or the controller 812 may otherwise be engaged to such components or other devices including various hardware and software to perform the functions and techniques discussed herein), a motor controller 820 (e.g., stepper motor controller), a motor encoder 822, a high voltage power source 824, a feedback loop 826, and a communications device (e.g., a Bluetooth chip or the like).

System preferences may be set up by accessing the system software, e.g., using the processor 814 and memory 816 of the controller 812. This may be done by connecting to the controller 812 physically (e.g., USB) or wirelessly (e.g., Bluetooth), or any combination thereof. An operator may enter their password which authorizes them to make changes to the system's software. For example, the operator may select ‘Timed sequence’ or the like from a drop down menu of ‘Predefined Sequence Modes’ or the like. By way of example, the drop down menu may resemble the following:

### Predefined Sequence Modes

Timed sequence
Untimed sequence
Overlap sequence

The operator may then select the sequence of each sensor. In this example, the operator has chosen Sensor B first, then Sensor A, and then Sensor C. The operator may then select the time duration that Sensor B is HIGH (e.g., 3 seconds), and the time delay between Sensor B switching to LOW and Sensor A switching to HIGH (e.g., 2 seconds). This process may be repeated until the entire sequence is mapped. These selections may resemble the following:

| Sequence | Component Type | Name | HIGH (s) | Delay (s) |
|---|---|---|---|---|
| First | Capacitive sensor | B | 3 | 2 |
| Second | Capacitive sensor | A | 4 | 3 |
| Third | Inductive sensor | C | 5 | N/A |

The operator may then adjust the sensitivity of the sequence. By decreasing the sensitivity, the operator can increase the width of the acceptability window around each point in the sequence when a sensor changes state. In this example, the operator has selected a static acceptability window of ±1.0 seconds. This means that if Sensor B was intended to switch states three seconds after the commencement of the sequence, it would be acceptable to change state anywhere between two and four seconds after the sequence has begun.

As this system can be battery powered, the operator may select to operate the system in ‘Sleep Mode.’ This means that the controller 812 and Sensor B, i.e., the first sensor in the sequence, may always be on, but no power will be distributed to the remaining system components until the sequence has begun, in an effort to conserve power. In this mode, power may be supplied only to the components that need to be powered for the sequence to commence.

Once the settings are complete and downloaded to the controller 812, the system may be ready for use.

The presence of a human hand within the working distance of a capacitive sensor 808 may be sufficient enough to cause that sensor to change state. For an inductive sensor 810, however, something metallic (e.g., a ring, bracelet, or the like) may need to be within the working distance of the sensor. In this example, Sensors B and A are capacitive and Sensor C is inductive.

To begin the sequence, the operator may place their bare hand within the working distance of Sensor B and hold it there for three seconds (±1 second), and then remove their hand from the sensor. The operator may wait for two seconds (±1 second) before placing their hand over Sensor A. They may then hold it there for four seconds (±1 second), and then remove it. The operator may wait three seconds (±1 second) and then place a metallic object into the working distance of Sensor C, wait five seconds (±1 second), and then remove the metallic object.

The controller (or data/cloud network) may then determine if the predefined sequence has been achieved. If true, it may send a signal to the motor controller 820 that drives DC stepper motor 802. The hidden compartment may now be accessible. The position of the compartment may be confirmed by motor encoder 822 and feedback loop 826.

### Example 2—Boat

In this example, a boat manufacturer has decided to install security systems into their boats to help to prevent theft. The security systems, which can be at least partially concealed, can prevent the engines from operating until the system has authorized this action. One electrical wire, which may be critical to each engine's operation, may be disrupted by an electrical switch (e.g., relay or transistor) that is under the control of said security system.

Due to the fiberglass construction of the area around the helm (steering wheel) in the exemplary boat, a capacitive sensor may be selected for this application as it can be fully functional through this non-conductive media. One capacitive sensor, which will be concealed within the fiberglass helm, and one mechanical switch, which will be exposed in this example, may be used.

This system may include a controller, software, a capacitive sensor, a mechanical switch, a least one electrical switch (e.g., relay or transistor), a power source, an audible alarm, and a communications device (e.g., Bluetooth/wireless chip).

The operator may setup the system preferences by accessing the system software. This may be done by connecting to the controller physically (e.g., USB) or wirelessly (e.g., Bluetooth, Wi-Fi, etc.). The operator may enter their password which authorizes them to make changes to the system's software. The operator may select ‘Untimed Sequence’ from the drop down menu of ‘Predefined Sequence Modes.’ By way of example, the drop down menu may resemble the following:

### Predefined Sequence Modes

Timed sequence
Untimed sequence
Overlap sequence

The operator may then define the sequence. In this example, the operator has chosen Sensor A first, and then Switch B. The operator may then select how much time (e.g., in seconds) before the system times out and reverts back to its ‘ready’ state. In this example, the operator has selected twenty seconds before the system times out. These selections may resemble the following:

| Sequence | Component Type | Name |
|---|---|---|
| First | Capacitive sensor | A |
| Second | Mechanical switch | B |

In this example, the operator has also selected to be notified, e.g., via e-mail and text message, if there are a failed number of access attempts past a certain number (e.g., three). A local alarm may also or instead sound if there are a failed number of attempts past a certain number (e.g., three).

In this example, the operator has selected ‘Always on’ for the power consumption mode. This means that the system will be energized when the boat's batteries are on (e.g., batteries on small boats are typically disconnected when the boat is not in use).

To begin the sequence, the operator may discreetly place their hand over Sensor A, which will initiate the twenty second time limit to complete the sequence. The operator may then remove their hand from the working volume of Sensor A and then change the state of Switch B. If these two actions were completed within the twenty second time limit, and in the correct order, the controller will supply power to each electrical switch, thus allowing the boat's engines to operate normally.

### Example 3—Home

In this example, an operator wants to limit access to a room in their basement where he/she stores valuables. In an effort to conceal the door of said room, the operator has successfully camouflaged it with its surroundings. The operator may not want to install a door handle or keypad, as this can reveal the existence of the room and the location of the door. In this example, the operator lives in a wood-frame home with drywall.

In this example, a two part system may be used. The first part of the system, which is installed adjacent to the concealed door, includes a primary controller that is electrically coupled to an actuator that unlocks the door. The second part of the system, which is installed at a remote location, acts as a Sleeper system and communicates with the primary controller wirelessly.

In this example, the primary system includes two capacitive sensors, which are concealed behind the drywall, adjacent to the hidden door. The secondary Sleeper system includes a single concealed optical sensor (e.g., photo-interrupt sensor) that is installed along the operator's route to the basement.

The optical sensor may be installed in such a way that allows the operator to discreetly activate it as they approach the concealed door, minimizing the change that an observer notices this action.

The primary and secondary systems may include controllers, software, capacitive sensors, an optical sensor, power sources, communication interfaces (e.g., Bluetooth/wireless chip), an electrical switch (e.g., transistor or relay to control an actuator), and an actuator (e.g., a locking mechanism).

The operator may setup system preferences by accessing the system software. This may be done by connecting to the controller physically (e.g., USB) or wirelessly (e.g., Bluetooth, Wi-Fi, etc.). The operator may enter their password which authorizes them to make changes to the controller's software.

The operator may initiate a ‘Secondary System Setup.’

To set up the Sleeper, the operator may select ‘Untimed sequence’ from the drop down menu of ‘Predefined Sequence Modes.’ By way of example, the drop down menu may resemble the following:

### Predefined Sequence Modes

Timed sequence
Untimed sequence
Overlap sequence

The operator may then define the sequence. In this case, as there is only one sensor in the Sleeper system, the operator includes only Optical Sensor A in the sequence. As the only sensor in the ‘Untimed Sequence’, Optical Sensor A will essentially act as a switch. As soon as Optical Sensor A is activated, the Sleeper system will send a signal to the primary controller, authorizing it to function for a predetermined amount of time. These selections may resemble the following:

| Sequence | Component Type | Name |
|---|---|---|
| First | Optical sensor | A |

The operator may then select the amount of time that, once the secondary ‘Sleeper’ system has been activated, the primary system is active. In this case the operator selects sixty seconds for the primary system to be active once the Sleeper has been activated.

The operator may then initiate a ‘Primary System Setup.’

For the primary system, the operator may select ‘Overlap sequence’ from the drop down menu of ‘Predefined Sequence Modes’. By way of example, the drop down menu may resemble the following:

### Predefined Sequence Modes

Timed sequence
Untimed sequence
Overlap sequence

The operator may then define the time duration of the overlap sequence. In this case, the operator enters fifteen seconds. The operator may then define the time periods within the fifteen seconds that each sensor is HIGH. These selections may resemble the following:

| Sequence | Component Type | Name | HIGH (s) |
|---|---|---|---|
| First | Capacitive sensor | B | 1 to 5; 10 to 15 |
| Second | Capacitive sensor | C | 5 to 15 |

To begin the sequence, the operator must activate the secondary ‘Sleeper’ system by blocking the optical path of Optical Sensor A. This results in a sixty second window in which the primary system is active (where after sixty seconds the primary system times out and becomes inactive). The operator may continue to the wall where the capacitive sensors are installed. The operator must then complete the 15 second overlap sequence before the sixty seconds times out. The operator may place their hand over Sensor B for five seconds and then remove it while placing their hand over Sensor C for the next 5 seconds. The operator may then activate both Sensors B and C for the remaining five seconds of the 15 second overlap sequence. If the controller's software (or data/cloud network) determines that the sensors were HIGH only during the predefined time periods (±tolerance band), it may unlock the door by energizing the actuator (e.g., a locking mechanism).

### Example 4—Desk Safe

In this example, an operator has a desk with a hidden compartment.

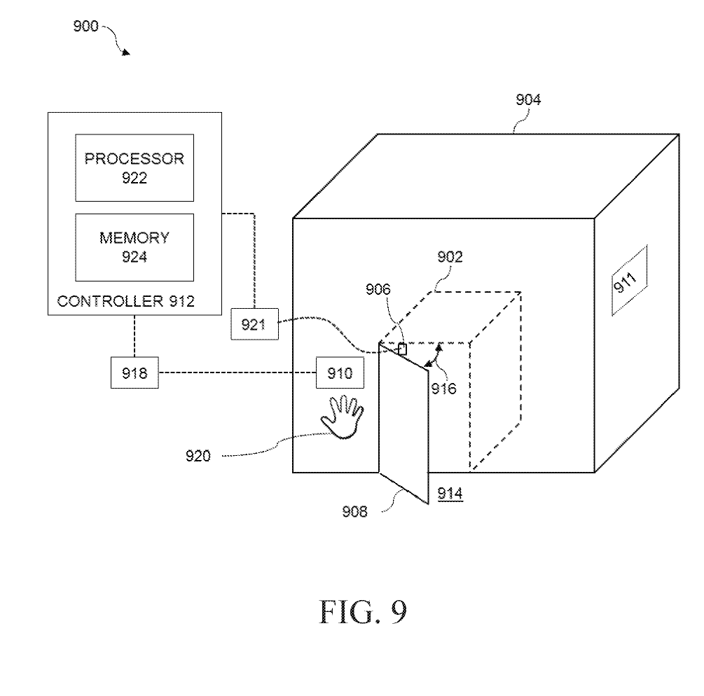

FIG. 9 illustrates a system with a controllable compartment based on detected operator inputs. In general, one or more implementations may include a system 900 comprising a compartment 902 in a structure 904, a mechanical element 906 engaged with a panel 908, one or more sensors 910, and a controller 912. The system 900, for example, may be to conceal, protect, safeguard, etc., an object by utilizing a plurality of concealed sensors that can be manipulated in a predefined or machine-learned sequence to access the object. In this manner, the predefined or machine-learned sequence acts as a password, passcode, or key to open a compartment 902 (e.g., using an activator or the like).

The compartment 902 may be disposed in the structure 904, where the compartment 902 is also engaged with the panel 908. The panel 908 may be movable between a first position in which the compartment 902 is at least partially concealed within the structure 904 and a second position in which the compartment 902 is at least partially exposed to an environment 914 external to the compartment 902. The compartment 902 may be any compartment, container, housing, and the like described herein or otherwise known in the art. In an aspect, the compartment 902 may be a safe, a room, a lockbox, a drawer, a cabinet, and the like. The compartment 902 may be concealed, partially concealed, or exposed within the structure 904.

The structure 904 may be any as described herein or otherwise known in the art. For example, the structure 904 may include a house, a room, a vehicle (e.g., automobile, bus, truck, boat, airplane, personal watercraft, all-terrain vehicle (ATV), motorcycle, etc.), an object, a piece of furniture, an item, and so forth, or any sub-component thereof, e.g., a wall, a piece, a section, a container, a tabletop, a cabinet, and so on.

The mechanical element 906 may be engaged with the panel 908 and controllable to move the panel 908 between the first position and the second position, e.g., as indicated by the arrows 916. The mechanical element 906 may be any as described herein or otherwise known in the art including without limitation a motor with corresponding movable parts (e.g., linear actuators, belts, pulleys, gears, and the like). The mechanical element 906 may also or instead include magnets, pumps, latches, locks, sliders, and the like.

The panel 908 may be any such that it conceals or partially conceals the compartment 902. For example, the panel 908 may include a door, a window, a mirror, a piece of material, a sealer, and so forth.

The one or more sensors 910 may be disposed within or adjacent to the structure 904. For example, the sensors may include one or more sensors 910 adjacent to, within, or on the panel 908, the compartment 902, or another component. The sensors may also or instead include a sleeper system 911, which is disposed away from the compartment 902. The sleeper system 911 may be located within or adjacent to the structure 904 or it may be completely separate from the structure 904. The one or more sensors 910 may be concealed within whatever location they are disposed, e.g., within the structure 904. The one or more sensors 910 may be any as described herein or otherwise known in the art. In general the one or more sensors 910 may be actuatable to send one or more signals 918 upon detection of one or more operator inputs 920, e.g., an activator as described herein (in this manner the sequence may include a predefined or machine-learned, time dependent or non-time dependent, activator sequence).

The controller 912 may include a processor 922 and a memory 924. The controller 912 may be programmable to set a predefined or machine-learned sequence of actuation for the one or more sensors 910. The predefined or machine-learned sequence of actuation may act as a key, passcode, password, or the like for accessing the compartment 902.

The processor 922 may be any as described herein or otherwise known in the art. The processor 922 may be included on the controller 912, or it may be separate from the controller 912, e.g., it may be included on a computing device in communication with the controller 912 or another component of the system 900. In one aspect, the processor 922 is included on or in communication with a server that hosts an application for operating and controlling the system 900.

The memory 924 may be any as described herein or otherwise known in the art. The memory 924 may contain computer code and may store data such as predefined or machine-learned sequences of actuation, attempts to actuate the sensors, or other relevant data.

The controller 912 may be further configured to receive the one or more signals 918 and to determine whether the predefined or machine-learned sequence of actuation has been achieved by the one or more operator inputs 920. The controller 912 may also or instead be configured to send a control signal 921 to the mechanical element 906 to move the panel 908 from the first position to the second position when it is determined that the predefined or machine-learned sequence of actuation has been achieved.

The operator inputs 920 may be any as discussed herein or otherwise known in the art, including without limitation hand gestures (or gestures of other body parts), touching or other physical contact (e.g., a fingerprint, a palm print, or just general contact), movement, scanning, an object held in a certain location(s), a force, a sound, an environmental condition (e.g., a temperature, a humidity, and so on), a pattern, and so forth.

In another embodiment, a system includes a compartment in a structure, where the compartment is engaged with a panel movable between a first position in which the compartment is at least partially concealed within the structure and a second position in which the compartment is at least partially exposed to an environment external to the structure. The system further includes a mechanical element engaged with the panel and controllable to move the panel between the first position and the second position. The system also includes a first sensor disposed within or adjacent to the structure, where the first sensor is actuatable to send at least a first signal upon detection of at least a predefined or machine-learned first operator input, and a second sensor disposed within or adjacent to the structure, where the second sensor is actuatable to send at least a second signal upon detection of at least a predefined or machine-learned second operator input. In the system, a controller may include a processor and a memory, where the processor is programmable to set a predefined or machine-learned sequence of actuation for at least the first sensor and second sensor. The controller may be configured to receive the first signal and the second signal and to determine whether the predefined or machine-learned sequence of actuation has been achieved by at least the first operator input and the second operator input. The controller may be further configured to send a third signal to the mechanical element to move the panel from the first position to the second position when it is determined that the predefined or machine-learned sequence of actuation has been achieved.

### Example 5—Machine-Learning

In this example, an operator has a desk with a hidden drawer. In addition to the hidden drawer, the desk has a planar array of capacitive sensors concealed beneath the tabletop. Although completely hidden by wood, the operator may be aware of each sensor's approximate location and working volumes. To access the hidden drawer, the operator must successfully perform a predefined or machine-learned sequence of sensor activation.

Instead of manually programming a sequence into the system's software, which would result in a ‘predefined’ sequence, the operator wishes to create a sequence simply by performing a gesture within the working volumes of the sensors. In this way, the system will learn the gesture by observing each sensor's output as the operator performs the gesture.

The operator may setup the system preferences by accessing the system software. This may be done by connecting to the controller physically (e.g., USB) or wirelessly (e.g., Bluetooth, Wi-Fi, etc.). The operator may enter their password which authorizes them to make changes to the system's software. The operator may select ‘Demonstrate sequence’ from the drop down menu of ‘Programming Modes.’ By way of example, the drop down menu may resemble the following:

### Programming Modes

Manually define sequence
Demonstrate sequence

Once the programming mode is selected, the operator may select the type of sequence. Selecting the type of sequence may tell the system whether or not time is an important variable to the operator. In this example, the time within the sequence that sensors are activated or deactivated is not important to the operator. Instead, the operator cares only about the sequential order of sensor activations. Thus, the operator selects ‘Untimed sequence’ from the drop down menu of ‘Machine-learned Sequence Modes.’ By way of example, the drop down menu may resemble the following:

### Machine-learned Sequence Modes

Timed sequence
Untimed sequence

Once the programming and sequence modes are selected, the operator may be presented an icon on an operator interface to start a demonstration, which may for example read, “Start.” When the operator selects the icon, they may begin a gesture. Once the demonstration has begun, the icon on the operator interface may switch to end the gesture, and may for example read, “Stop.” Alternatively, the operator may use voice commands to start and stop the demonstration.

The operator may use their hand to perform a gesture within the working volume of at least one sensor. At the end of the gesture, the operator may manually tap the icon to end the demonstration or use voice commands to end the demonstration.

The operator interface may also provide feedback to the operator such as a map of sensor locations, indicators showing when each sensor is active, a running log of sensor activations such that the operator may be aware of the sequence as it is being recorded, an analog readout of each sensor's output, or a visual representation of the sequence.

When the gesture has been demonstrated once, the software may prompt the operator to repeat the gesture process several more times, until the gesture is adequately mapped by the software. Alternatively, the operator may review the data recorded and opt to accept the gesture as-is.

The operator may then adjust the sensitivity of the machine-learned sequence. Adjusting the sensitivity may include the acceptance of some degree of time or positional errors of the gesture performed by the operator. In this case, the operator sets the sensitivity to its maximum setting, meaning that the sequence must be performed perfectly; all sensors must be activated in the correct sequence. The system may now be ready for use.

To gain access to the hidden drawer, the operator must repeat their gesture and activate the sensors in the exact sequence as previously recorded. If successful, the controller may change the state of the container, granting the operator access to the hidden drawer.

### Example 6—Verbal Command

In this example, the operator stores items in a nightstand drawer that may be hazardous to children.

The operator usually does not lock this drawer because they want quick access to its contents in case of a home intrusion, but the operator has growing concerns about their children, or children's friends, finding such items. The operator decides to use the technology described in this disclosure to gain quick access to the nightstand drawer. As this system may operate without physical keys, the operator may be confident that children will not be able to gain access to the drawer. The operator also does not want the drawer to inadvertently open when the nightstand is being cleaned or dusted.

This system may include a controller, software, an inductive sensor, an acoustic sensor (e.g., a microphone), an electrical switch (e.g., transistor), at least one power source (e.g., battery or 110V AC), an actuator (e.g., solenoid), and a communications device (e.g., Bluetooth/wireless chip).

In this case, the operator has decided to use an inductive sensor because it has less of a chance of being inadvertently activated, as it will not respond to a human hand. The inductive sensor may require something metallic, such as the operator's wedding band, to be activated.

Additionally, the operator has decided to pair the inductive sensor with an acoustic sensor for an added level of security. The inductive sensor may be positioned underneath the top surface of the nightstand, concealed by wood. The acoustic sensor may be positioned anywhere on the nightstand, but preferably out of sight, such as underneath the nightstand.

The operator may setup the system preferences by accessing the system software. This may be done by connecting to the controller physically (e.g., USB) or wirelessly (e.g., Bluetooth, Wi-Fi, etc.). The operator may enter their password which authorizes them to make changes to the system's software. The operator may select ‘Demonstrate sequence’ from the drop down menu of ‘Programming Modes.’ By way of example, the drop down menu may resemble the following:

### Programming Modes

Manually define sequence
Demonstrate sequence

Once the programming mode is selected, the operator may select the type of sequence. Selecting the type of sequence will tell the system whether or not time is an important variable to the operator. In this example, the time within the sequence that sensors are activated or deactivated is not important to the operator. Instead, the operator cares only about the sequential order of sensor activations. Thus, the operator selects ‘Untimed sequence’ from the drop down menu of ‘Machine-learned Sequence Modes.’ By way of example, the drop down menu may resemble the following:

### Machine-Learned Sequence Modes

Timed sequence
Untimed sequence

Once the programming and sequence modes are selected, the operator may be presented an icon on an operator interface to start a demonstration, which may for example read, “Start.” When the operator selects the icon, they may begin their demonstration. Once the demonstration has begun, the icon on the operator interface may switch to end the demonstration, and may for example read, “Stop.”

The operator interface may also provide feedback to the operator such as a map of sensor locations, indicators showing when each sensor is active, a running log of sensor activations such that the operator may be aware of the sequence as it is being recorded, an analog readout of each sensor's output, or a visual representation of the sequence.

The operator may place something metallic, such as their wedding band, within the working volume of the inductive sensor. The operator may then verbalize a sound, word or phrase such as, “Wrong house.” When the demonstration is complete, the operator may manually tap the icon on the operator interface to end the demonstration. The system software may prompt the operator to repeat the demonstration several more times, until the sequence is adequately mapped by the software. Alternatively, the operator may review the data recorded and opt to accept the sequence as-is.

The operator may then ‘add an operator’ to the system so the operator's spouse may also gain access to the drawer. The spouse, known to the system's software as ‘User 2’, will repeat the demonstrations until their sequence is adequately mapped.

The operator(s) may then be prompted to adjust the sensitivity of the sequence. As the operators' vocal commands will never be identical to their original demonstrations, a sensitivity adjustment may be necessary. The software may present this sensitivity adjustment as a ‘percentage of certainty’. In this case, the operators have selected 90% for their sensitivity adjustment. This means that the software must have an audio match of greater than or equal to 90% to provide a positive result. This way, if the operators say their phrases a little faster or slower, or at a slightly different pitch, the system will still grant them access.

The system may now be ready for use.

To gain access to the locked drawer, either User 1 or User 2 must place something metallic within the working volume of the inductive sensor and say, “Wrong house.” If done correctly within 10 seconds, as determined by the controller's software or data/cloud network, the controller may change the state of the container, granting the operator(s) access to the locked drawer.

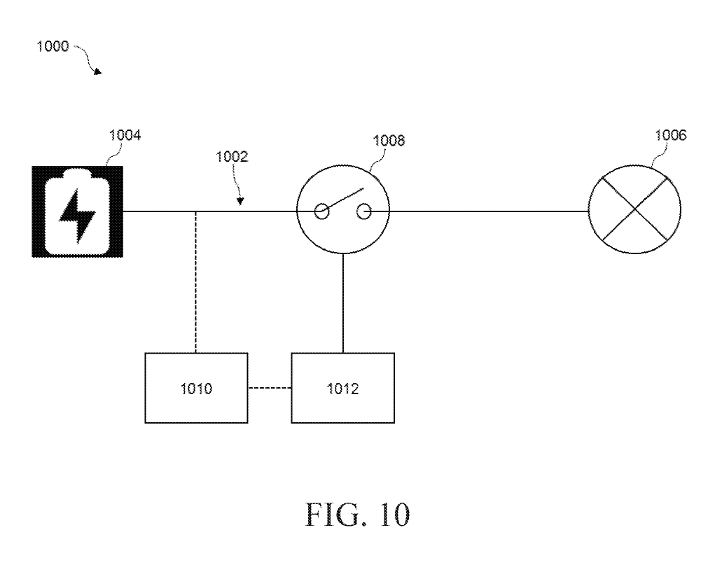

FIG. 10 illustrates a system with a controllable circuit based on detected operator inputs. Implementations may also or instead include a system 1000 in which a circuit 1002 is controllable between a first state in which power from a power source 1004 is withheld from an endpoint 1006, and a second state in which power from a power source 1004 is provided to the endpoint 1006. The system 1000 may be similar to Example 2 provided herein, or any in which power from a power source 1004 is to be withheld until certain actions are taken or operator inputs are provided. In an aspect, the circuit 1002 is an electrical circuit and power is withheld from the endpoint 1006 when in the first state through an open electrical connection that is closed upon switching from the first state to the second state, and vice-versa.

The power source 1004 may be any as described herein or otherwise known in the art. By way of example, the power source 1004 may be an electrical power source (e.g., a battery, an AC power source from a power grid or the like, a wired or wireless power source, and so forth), a mechanical power source, a renewable energy power source, and so forth. The power supplied by the power source 1004 may be electricity, mechanical power, wind, fuel, fluid (e.g., air, water, etc.), and so on.

The endpoint 1006 may be any as described herein or otherwise known in the art. By way of example, the endpoint 1006 may be a mechanical device, an electrical device, or any combination thereof. The endpoint 1006 may include without limitation an engine, a pump, a light, an appliance, a locking device, a computing device, and so forth.

The first state and the second state may be provided for by one or more switching devices 1008 such as a transistor, a switch, a relay and so forth. The switching device 1008 may also or instead include a valve or other mechanical device for allowing and restricting the flow of a fluid. One of ordinary skill in the art will recognize that switching from the first state to the second state may be accomplished through many mechanical and electrical devices (and combinations thereof), where any and all are intended to fall within the scope of this disclosure.

The system 1000 may further include one or more sensors 1010. The one or more sensors 1010 may be disposed within a structure or the like, where the one or more sensors 1010 are actuatable to send one or more signals upon detection of one or more operator inputs. In one implementation, the structure is disposed within or adjacent to the endpoint 1006. In an aspect, the one or more sensors 1010 send signals which can start a process that eventually changes the system from the first state to the second state, or vice-versa.

The system 1000 may also include a controller 1012 including a processor and a memory, where the processor is programmable to set a predefined or machine-learned sequence of actuation for the one or more sensors 1010. The controller 1012 may be configured to receive the one or more signals and to determine whether the predefined or machine-learned sequence of actuation has been achieved by the one or more operator inputs. The controller 1012 may be further configured to send a signal to the circuit 1002 (e.g., to the one or more switching devices 1008) to switch from the first state to the second state (or vice-versa) when it is determined that the predefined or machine-learned sequence of actuation has been achieved.

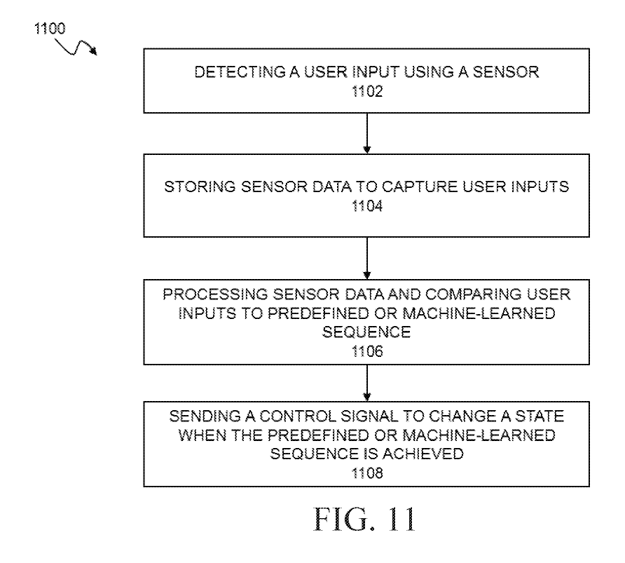

FIG. 11 is a flow chart of a method for detecting operator inputs.

As shown in step 1102, the method 1100 may include detecting one or more user/operator inputs using a sensor.

As shown in step 1104, the method 1100 may include the collection or storage of sensor data to capture all user/operator inputs.

As shown in step 1106, the method 1100 may include the data processing and comparison of the operator inputs to a predefined or machine-learned sequence of actuation for the one or more sensors, thereby determining whether the predefined or machine-learned sequence of actuation has been achieved by the one or more operator inputs. This comparison may be achieved using Digital Signal Processing software or gesture recognition software, which may be performed by the controller or another component of the system having such processing capabilities, such as a data/cloud network.

As shown in step 1108, the method 1100 may include sending a control signal to a mechanical element to change a state of a compartment when it is determined that predefined or machine-learned sequence of actuation has been achieve by the one or more operator inputs. Again, this step 1108 may be performed by the controller or another component of the system having such processing capabilities. Alternatively, the control signal may be sent to an electrical element to change the state of an electrical circuit, or otherwise to an element to change the state of a system for supplying power to an endpoint when it is determined that predefined or machine-learned sequence of actuation has been achieve by the one or more operator inputs.

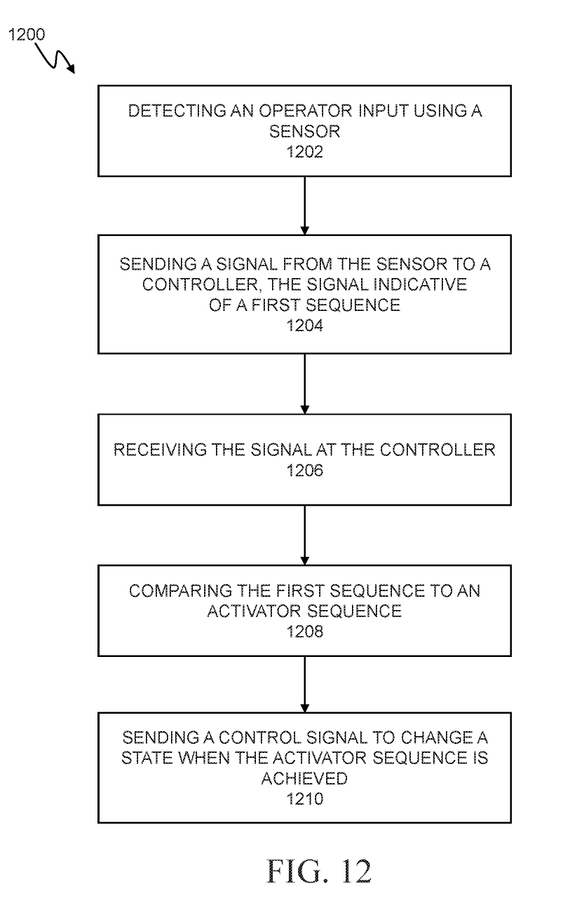

FIG. 12 is a flow chart of a method for detecting operator inputs to change the state of a container.

As shown in step 1202, the method 1200 may include detecting, through one or more sensors at least partially concealed in a structure, one or more operator inputs in a first sequence.

As shown in step 1204, the method 1200 may include sending one or more signals from the one or more sensors to a controller. The one or more signals may be indicative of the first sequence.

As shown in step 1206, the method 1200 may include receiving the one or more signals at the controller.

As shown in step 1208, the method 1200 may include comparing the first sequence to a predefined or machine-learned activator sequence for the one or more sensors thereby determining whether the activator sequence has been achieved by the one or more operator inputs.

As shown in step 1210, the method 1200 may include sending a control signal to a mechanical element to change a state of a concealed compartment when it is determined that the activator sequence has been achieved by the one or more operator inputs.

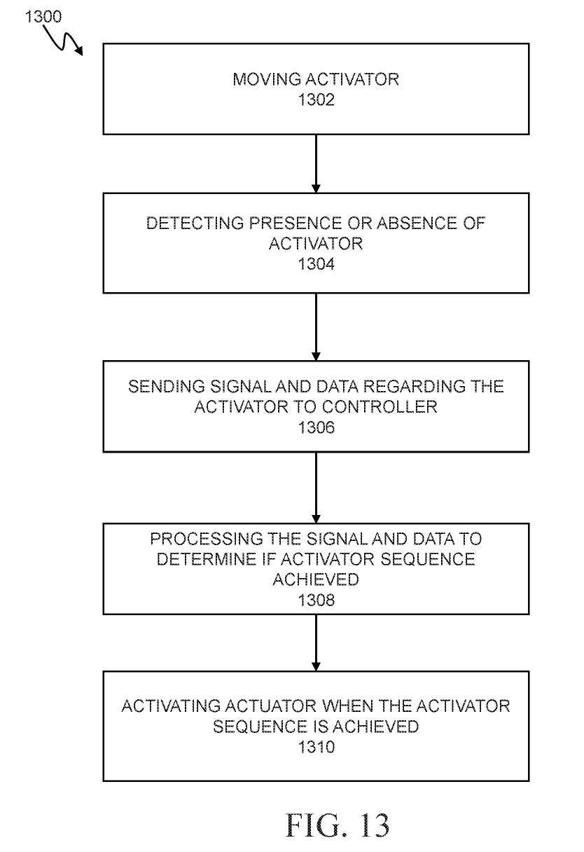

FIG. 13 is a flow chart of a method of changing a state of a container.

As shown in step 1302, the method 1300 may include moving an activator by an operator in a predefined or machine-learned, time dependent or non-time dependent, activator sequence in free space in proximity to at least one sensor concealed by concealment material.

As shown in step 1304, the method 1300 may include detecting a presence or an absence of the activator by the at least one sensor.

As shown in step 1306, the method 1300 may include sending a signal communicating the presence or absence of the activator to a controller and data related to movement of the activator by the operator, if present.

As shown in step 1308, the method 1300 may include processing the signal and the data by the controller to determine if the activator sequence has been achieved the movement of the activator by the operator.

As shown in step 1310, the method 1300 may include activating an actuator by the controller upon confirmation that the activator sequence has been achieved thereby changing a state of the container.

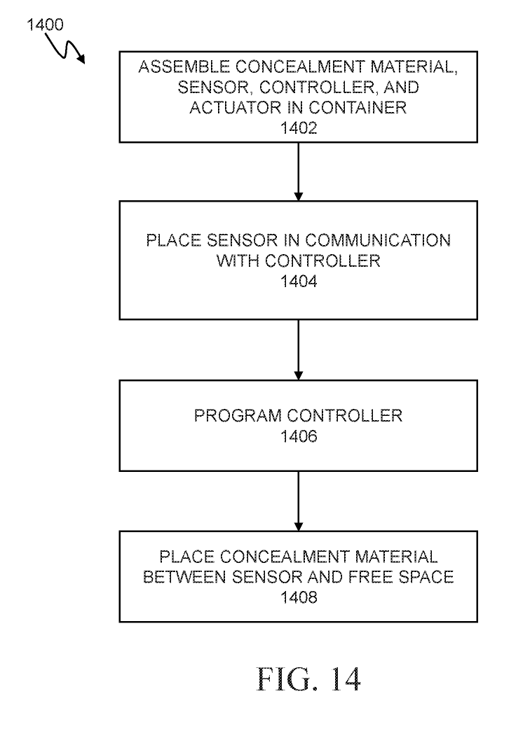

FIG. 14 is a flow chart of a method of manufacturing a container.

As shown in step 1402, the method 1400 may include assembling concealment material, at least one sensor, a programmable controller, and an actuator within the container.

As shown in step 1404, the method 1400 may include placing the at least one sensor in electronic communication with the programmable controller. The at least one sensor may be capable of detecting and communicating a presence or an absence of an activator to the programmable controller.

As shown in step 1406, the method 1400 may include programming the programmable controller to receive input from the at least one sensor such that the programmable controller and at least one sensor are capable of detecting a predefined or machine-learned, time dependent or non-time dependent, activator sequence performed by the activator in free space.

As shown in step 1408, the method 1400 may include placing the concealment material between the at least one sensor and the free space.

As shown in step 1410, the method 1400 may include programming the programmable controller to determine if the activator sequence has been achieved.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote operator, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A system for activating one or more actuators upon detection of an activator sequence by one or more sensors, the system comprising:
a controller;
an actuator in electronic communication with the controller; and
at least one sensor in electronic communication with the controller, the controller programmed to receive an input from the at least one sensor upon a detection by the at least one sensor of a sensed sequence performed by an activator, the controller programmed to determine if the sensed sequence substantially matches a predefined or machine-learned, time dependent or non-time dependent, activator sequence, and the controller programmed to activate the actuator when the sensed sequence substantially matches the activator sequence.

2. The system of claim 1, wherein the activator sequence is an operator motion in free space.

3. The system of any of claim 2, wherein the controller is capable of being programmed by an operator via a physical or wireless connection.

4. The system of any of claim 3, wherein the at least one sensor is capable of responding to a presence or absence of motion of the activator in free space.

5. The system of any of claim 4, wherein the at least one sensor is selected from the group consisting of inductive, acoustic, capacitive, pressure, temperature, infrared, optical, ultrasonic, and magnetic sensors.

6. The system of any of claim 5, wherein the at least one sensor can be turned on or off by an operator to change the activator sequence.

7. The system of any of claim 6, wherein the activator is an operator body part.

8. The system of any of claim 7, wherein the activator comprises a predefined shape and size.

9. The system of any of claim 8, wherein the activator is constructed of magnetic or non-magnetic metal.

10. The system of any of claim 9, wherein the activator comprises physical properties of one or more of liquid, light, heat, sound, or magnetism.

11. The system of any of claim 10, wherein the actuator is selected from the group consisting of a lock, motor, pump, transistor, relay, solenoid, spring-loaded device, switch, and computer program.

12. The system of any of claim 11 housed by a container.

13. The system of claim 12, wherein concealment material is placed between the at least one sensor and the activator.

14. The system of any of claim 13, wherein actuator activation changes a state of the container to a desired condition.

15. The system of claim 14, wherein change in the state of the container is selected from the group consisting of a change in container accessibility, a change from open to closed, closed to open, locked to unlocked, unlocked to locked, enabled to disabled, and disabled to enabled.

16. The system of any of claim 15, wherein the container is selected from the group consisting of a piece of furniture, a home, a boat, a car, a safe, a garage, and a safe room.

17. The system of any of claim 16, wherein the concealment material is non-reactive with respect to the at least one sensor.

18. The system of any of claim 17, wherein the concealment material is selected from the group consisting of wood, ceramic, plastic, drywall, sheet rock, stone, brick, fiberglass, carbon fiber, glass, and metal.

19. A system comprising:
a compartment in a structure, the compartment engaged with a panel movable between a first position in which the compartment is at least partially concealed within the structure and a second position in which the compartment is at least partially exposed to an environment external to the compartment;
a mechanical element engaged with the panel and controllable to move the panel between the first position and the second position;
one or more sensors disposed within or adjacent to the structure, the one or more sensors actuatable to send one or more signals upon detection of one or more operator inputs; and
a controller including a processor and a memory, the processor programmable to set a predefined or machine-learned, activator sequence for the one or more sensors, the controller configured to receive the one or more signals and to determine whether the predefined or machine-learned, time dependent or non-time dependent, activator sequence has been achieved by the one or more operator inputs, and the controller further configured to send a control signal to the mechanical element to move the panel from the first position to the second position when it is determined that predefined or machine-learned activator sequence has been achieved.

20. The system of claim 19, wherein the one or more sensors are concealed within the structure.

21. A system comprising:
a circuit controllable between a first state in which power is withheld from an endpoint and a second state in which power is provided to the endpoint;
one or more sensors disposed within a structure, the one or more sensors actuatable to send one or more signals upon detection of one or more operator inputs; and
a controller including a processor and a memory, the processor programmable to set a predefined or machine-learned, time dependent or non-time dependent, activator sequence for the one or more sensors, the controller configured to receive the one or more signals and to determine whether the predefined or machine-learned activator sequence has been achieved by the one or more operator inputs, and the controller further configured to send a control signal to the circuit to switch from the first state to the second state when it is determined that the activator sequence has been achieved.

22. The system of claim 21, wherein the structure is disposed within or adjacent to the endpoint.

23. The system of any of claims 21 and 22, wherein the circuit is an electrical circuit and power is withheld from the endpoint when in the first state through an open electrical connection that is closed upon switching from the first state to the second state.

24. A system comprising:
a compartment in a structure, the compartment engaged with a panel movable between a first position in which the compartment is at least partially concealed within the structure and a second position in which the compartment is at least partially exposed to an environment external to the structure;
a mechanical element engaged with the panel and controllable to move the panel between the first position and the second position;
a first sensor disposed within or adjacent to the structure, the first sensor actuatable to send at least a first signal upon detection of at least a predefined or machine-learned first operator input;
a second sensor disposed within or adjacent to the structure, the second sensor actuatable to send at least a second signal upon detection of at least a predefined or machine-learned second operator input; and
a controller including a processor and a memory, the processor programmable to set a predefined or machine-learned, time dependent or non-time dependent, activator sequence for at least the first sensor and second sensor, the controller configured to receive the first signal and the second signal and to determine whether the predefined or machine-learned activator sequence has been achieved by at least the first operator input and the second operator input, and the controller further configured to send a third signal to the mechanical element to move the panel from the first position to the second position when it is determined that predefined or machine-learned activator sequence has been achieved.

25. A method of changing a state of a container, the method comprising:
moving an activator by an operator in a predefined or machine-learned, time dependent or non-time dependent, activator sequence in free space in proximity to at least one sensor concealed by concealment material;
detecting a presence or an absence of the activator by the at least one sensor;
sending a signal communicating the presence or absence of the activator to a controller and data related to movement of the activator by the operator, if present;
processing the signal and the data by the controller to determine if the activator sequence has been achieved the movement of the activator by the operator; and
activating an actuator by the controller upon confirmation that the activator sequence has been achieved thereby changing a state of the container.

26. A method comprising:
detecting, through one or more sensors at least partially concealed in a structure, one or more operator inputs in a first sequence;
sending one or more signals from the one or more sensors to a controller, the one or more signals indicative of the first sequence;
receiving the one or more signals at the controller;
comparing the first sequence to a predefined or machine-learned activator sequence for the one or more sensors thereby determining whether the activator sequence has been achieved by the one or more operator inputs; and
sending a control signal to a mechanical element to change a state of a concealed compartment when it is determined that the activator sequence has been achieved by the one or more operator inputs.

27. A container comprising:
concealment material, at least one sensor, a programmable controller, and an actuator;
wherein the container houses the concealment material, the at least one sensor, the programmable controller, and the actuator;
wherein the at least one sensor is in electronic communication with both the actuator and the programmable controller;
wherein the programmable controller is programmed to receive input from the at least one sensor and is capable of detecting a predefined or machine-learned, time dependent or non-time dependent, activator sequence performed by an activator;
wherein the concealment material is placed between the at least one sensor and the activator; and
wherein upon the at least one sensor detecting and communicating a presence or absence of the activator to the programmable controller, the programmable controller determines if the activator sequence has been achieved, and the controller activates the actuator when it is determined that the activator sequence has been achieved thereby changing a state of the container to a desired condition.

28. A method of manufacturing a container, the method comprising:
assembling concealment material, at least one sensor, a programmable controller, and an actuator within the container;
placing the at least one sensor in electronic communication with the programmable controller, the at least one sensor capable of detecting and communicating a presence or an absence of an activator to the programmable controller;
programming the programmable controller to receive input from the at least one sensor such that the programmable controller and at least one sensor are capable of detecting a predefined or machine-learned, time dependent or non-time dependent, activator sequence performed by the activator in free space;
placing the concealment material between the at least one sensor and the free space; and
programming the programmable controller to determine if the activator sequence has been achieved.
